(19) United States
(12) Patent Application Publication
(10) Pub. No.: US 2025/0121365 A1
(43) Pub. Date: Apr. 17, 2025

(54) DRIVING DEVICE AND LIQUID INJECTION DEVICE INCLUDING THE SAME

(71) Applicant: Pukyong National University Industry-University Cooperation Foundation, Busan (KR)

(72) Inventors: Joong Ho SHIN, Busan (KR); Min Seon KIM, Ulsan (KR)

(21) Appl. No.: 18/913,649

(22) Filed: Oct. 11, 2024

(30) Foreign Application Priority Data
Oct. 12, 2023 (KR) 10-2023-0135921

(51) Int. Cl. B01L 3/02

(52) U.S. Cl. CPC B01L 3/0234; B01L 3/0227; B01L 2400/0478

(57) ABSTRACT

A driving device and a liquid injection device including the same are disclosed. A driving device according to an aspect may include a frame; a rotation shaft rotatably supported by the frame; a rotation driving unit configured to rotate the rotation shaft; a plurality of pinions configured to be spaced apart in the longitudinal direction of the rotation shaft and respectively coupled to the rotation shaft; and a plurality of racks configured to be engaged with the plurality of pinions, respectively and configured to move forward in a direction perpendicular to the longitudinal direction of the rotation shaft, wherein when the rotation shaft rotates, the engagement of the plurality of pinions and the plurality of racks that respectively correspond to each other is sequentially performed.

### CROSS-REFERENCE TO RELATED APPLICATION

This application claims priority to and the benefit of Korean Patent Application No. 10-2023-0135921, filed on Oct. 12, 2023, the disclosure of which is incorporated herein by reference in its entirety.

### TECHNICAL FIELD

The present invention relates to a driving device and a liquid injection device including the same, and more particularly, to a driving device that provides a driving force to inject several liquids sequentially and a liquid injection device including the same.

### BACKGROUND

Enzyme-linked immunosorbent assay (ELISA) is a method of measuring antigen or antibody amount using antigen-antibody reactions with enzymes as markers.

Traditionally, immunoassays involving complex and sequential samples and reagent pipetting, such as enzyme-linked immunosorbent assay, were performed by an operator directly pipetting the appropriate amount of samples and reagents sequentially.

However, because sample and reagent pipetting by an operator is performed based on the operator's experience and know-how, there was a problem that it is difficult to perform an accurate amount of sample and reagent pipetting according to the operator's skill level, and accurate analysis or diagnosis becomes difficult if the pipetting order of the sample and reagent is not correct.

In addition, in the process of sequentially performing sample and reagent pipetting by an operator, there may be a problem in which the subject of analysis or diagnosis is contaminated by the operator's mistake.

### SUMMARY

### Technical Problem

The present invention aims to solve the above problems, and the present invention is directed to providing a driving device that provides a driving force to inject several liquids sequentially to minimize operator intervention and a liquid injection device including the same.

The problems of the present invention are not limited to those mentioned above, and other problems not mentioned will be clearly understood by those of ordinary skill in the art from the following description.

### Technical Solution

According to an aspect of the present invention, provided is a driving device, including a frame; a rotation shaft rotatably supported by the frame; a rotation driving unit configured to rotate the rotation shaft; a plurality of pinions configured to be spaced apart in the longitudinal direction of the rotation shaft and respectively coupled to the rotation shaft; and a plurality of racks configured to be engaged with the plurality of pinions, respectively and configured to move forward in a direction perpendicular to the longitudinal direction of the rotation shaft, wherein when the rotation shaft rotates, the engagement of the plurality of pinions and the plurality of racks that respectively correspond to each other is sequentially performed.

In this case, the rotation driving unit may operate without external power.

In this case the rotation driving unit may include a spiral spring; a driving gear coupled to a rotation shaft of the spiral spring; and a driven gear fixedly coupled to the rotation shaft and configured to rotate in engagement with the driving gear.

In this case, a seating groove may be formed in the frame, the spiral spring being coupled to and seated in the seating groove.

Meanwhile, the formation range of gear teeth of each of the plurality of pinions may have a different angular range in the circumferential direction of the rotation shaft.

In this case, in the order of sequential engagement of the plurality of pinions and the plurality of racks that respectively correspond to each other, the formation range of the gear teeth of a prior order pinion and the formation range of the gear teeth of a subordinate order pinion may partially overlap.

Alternatively, in the order of sequential engagement of the plurality of pinions and the plurality of racks that respectively correspond to each other, the formation range of the gear teeth of a prior order pinion and the formation range of the gear teeth of a subordinate order pinion may do not overlap.

Meanwhile, each of the plurality of pinions may include a plurality of pinion units coupled to each other in the circumferential direction of the rotation shaft, and at least one of the plurality of pinion units may be a first pinion unit having gear teeth formed on an outer circumferential surface thereof, and the rest may be a second pinion unit having no gear teeth formed on an outer circumferential surface thereof.

In this case, each of the plurality of pinion units may include a protruding coupling portion and a concave coupling portion for coupling with adjacent other pinion units at one side and the other side in the circumferential direction of the rotation shaft.

Meanwhile, a plurality of guides coupled to the plurality of racks, respectively, and configured to guide the forward movement of the plurality of racks, respectively, may be formed in the frame.

According to another aspect of the present invention, a liquid injection device may be provided, including the driving device; and a plurality of syringes supported by the frame, the plurality of syringes corresponding to the plurality of racks, respectively, wherein the plurality of syringes are compressed by being pushed by corresponding ends of the plurality of racks, respectively, and different liquids are stored in the plurality of syringes, respectively.

In this case, the plurality of syringes may be supported by the frame through a plurality of syringe coupling members detachably coupled to the frame, respectively.

Meanwhile, the liquids stored in the plurality of syringes, respectively, may be sequentially injected to an injection target member; and a plurality of sub flow paths through which the liquids stored in the plurality of syringes, respectively, are sequentially injected, and a main flow path in which the plurality of sub flow paths are combined may be formed in the injection target member; and a fixing portion to which a specific object may be formed on the main flow path.

### Advantageous Effects

In the liquid injection device according to the present embodiment, the driving device that sequentially provides a driving force to a plurality of syringes operates to sequentially inject different liquids stored in each of the plurality of syringes in an accurate amount into an injection target member, thereby making it possible to inject different liquids sequentially and in an accurate amount while minimizing operator intervention, reducing cross-contamination and enabling more accurate analysis and diagnosis compared to when operators manually inject different liquids.

In addition, the liquid injection device can be recognized as an eco-friendly device with improved portability and convenience by including a driving device that provides driving force without external power.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view of a liquid injection device viewed from one direction according to an exemplary embodiment of the present invention.

FIG. 2 is a view of a driving device viewed from one direction according to an exemplary embodiment of the present invention.

FIG. 3 is a view of a driving device viewed from another direction according to an exemplary embodiment of the present invention.

FIG. 4 is a view showing a frame of a driving device according to an exemplary embodiment of the present invention.

FIG. 5 is a view of a rotation shaft of a driving device according to an exemplary embodiment of the present invention and some components coupled thereto as viewed from one direction.

FIG. 6 is a view of a rotation shaft of a driving device according to an exemplary embodiment of the present invention and some components coupled thereto as viewed from another direction.

FIG. 7 is a view for explaining a gear teeth formation range of a plurality of pinions according to an exemplary embodiment of the present invention.

FIG. 8 is a view showing a pinion according to an exemplary embodiment of the present invention.

FIG. 9 is a view showing a first pinion unit shown in FIG. 8.

FIG. 10 is a view showing a second pinion unit constituting the pinion shown in FIG. 8.

FIG. 11 is a view showing a plurality of syringes included in a liquid injection device according to an exemplary embodiment of the present invention.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Hereinafter, a driving device and a liquid injection device including the same according to an exemplary embodiment of the present invention will be described with reference to the drawings.

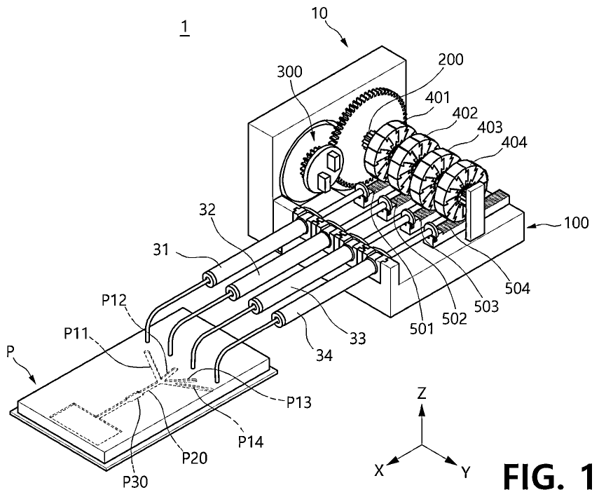

FIG. 1 is a perspective view of a liquid injection device viewed from one direction according to an exemplary embodiment of the present invention.

Referring to FIG. 1, the liquid injection device 1 according to the present embodiment may include a driving device 10 and a plurality of syringes 31, 32, 33, and 34.

In the liquid injection device 1 according to the present embodiment, the driving device 10 that sequentially provides a driving force to the plurality of syringes 31, 32, 33, and 34 may sequentially inject different liquids stored in each of the plurality of syringes 31, 32, 33, and 34 in an accurate amount into an injection target member P.

This makes it possible to inject different liquids sequentially and in an accurate amount while minimizing operator intervention, reducing cross-contamination and enabling more accurate analysis and diagnosis compared to when operators manually inject different liquids. In addition, the liquid injection device can be recognized as an eco-friendly device with improved portability and convenience by including a driving device that provides driving force without external power.

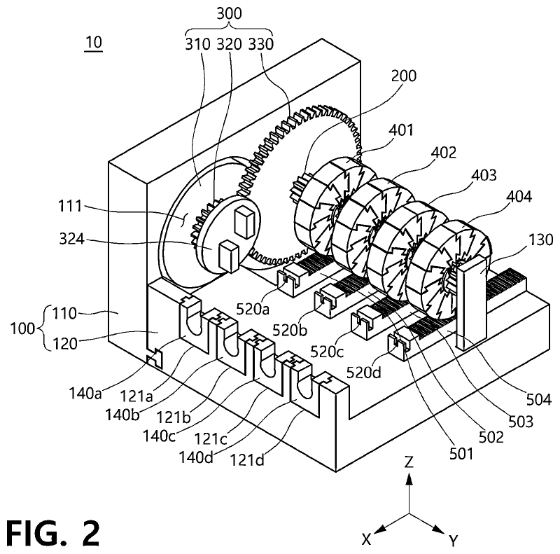

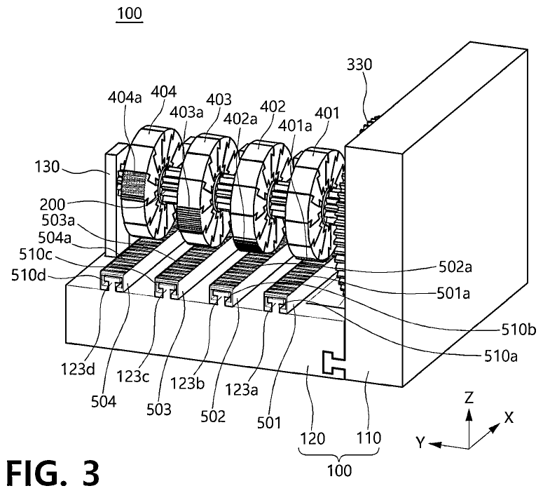

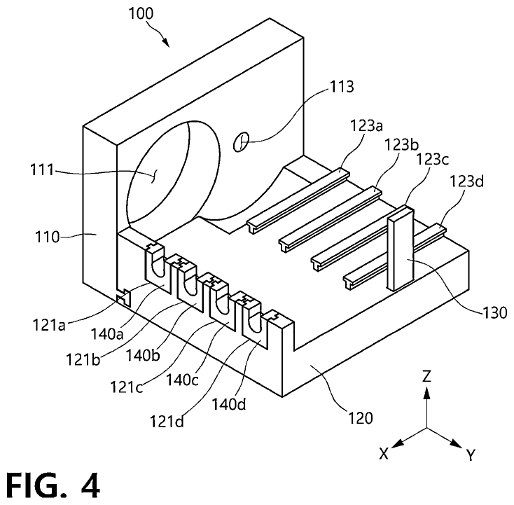

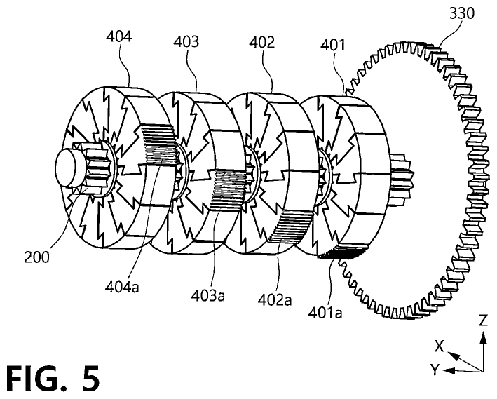

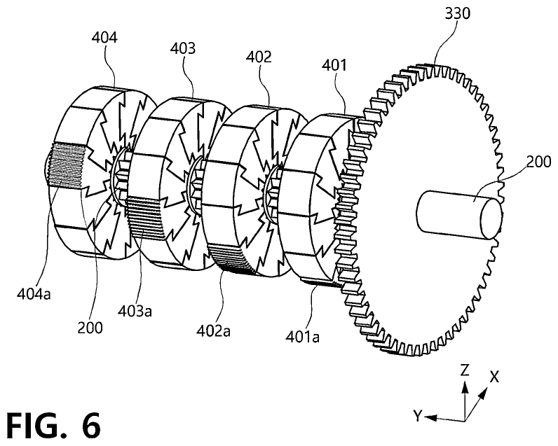

FIG. 2 is a view of a driving device viewed from one direction according to an exemplary embodiment of the present invention, FIG. 3 is a view of a driving device viewed from another direction according to an exemplary embodiment of the present invention, FIG. 4 is a view showing a frame of a driving device according to an exemplary embodiment of the present invention, FIG. 5 is a view of a rotation shaft of a driving device according to an exemplary embodiment of the present invention and some components coupled thereto as viewed from one direction, and FIG. 6 is a view of a rotation shaft of a driving device according to an exemplary embodiment of the present invention and some components coupled thereto as viewed from another direction.

Referring to FIGS. 1 to 6, the driving device 10 according to the present embodiment may be configured to include a frame 100, a rotation shaft 200, a rotation driving unit 300, a plurality of pinions 401, 402, 403, and 404, and a plurality of racks 501, 502, 503, and 504.

The frame 100 is a component for supporting the rotation shaft 200 or the like to be described later.

The frame 100 may be configured to include a first frame 110 and a second frame 120 coupled to each other.

A seating groove 111 in which a spiral spring 310 to be described later is seated and a support groove 113 rotatably supporting one end of the rotation shaft 200 to be described later may be formed in the first frame 110.

A bracket 130 by which the other end of the rotation shaft 200 to be described later is rotatably supported may be coupled to the second frame 120. In this case, the bracket 130 may be made separately from the second frame 120 and may be integrally coupled to the second frame 120. Alternatively, the bracket 130 may be made integrally with the second frame 120.

A support groove (not shown) for rotatably supporting the other end of the rotation shaft 200, although not shown in FIG. 4, may be formed in the bracket 130.

A plurality of guides 123a, 123b, 123c, and 123d may be formed in the second frame 120 to guide the racks 501, 502, 503, and 504, respectively, to be described later when the plurality of racks 501, 502, 503, and 504 move forward. This will be discussed later.

A plurality of syringe support members 140a, 140b, 140c, and 140d may be coupled to the second frame 120. The plurality of syringe support members 140a, 140b, 140c and 140d may support parts of the plurality of syringes 31, 32, 33, and 34, respectively, to be described later. A syringe seating groove in which a part of each corresponding syringe 31, 32, 33, and 34 is seated may be formed on each of the syringe support members 140a, 140b, 140c, and 140d.

A plurality of coupling groove portions 121a, 121b, 121c, and 121d to which the plurality of syringe support members 140a, 140b, 140c, and 140d can be coupled, respectively, may be formed in the second frame 120. The plurality of syringe support members 140a, 140b, 140c, and 140d may be detachably coupled to the plurality of corresponding coupling groove portions 121a, 121b, 121c, and 121d.

An operator may couple each of the syringe support members 140a, 140b, 140c, and 140d to the second frame 120 while supporting each of the syringes 31, 32, 33, and 34 corresponding to each of the syringe support members 140a, 140b, 140c, and 140d, or may support each of the syringes 31, 32, 33, and 34 corresponding to each of the syringe support members 140a, 140b, 140c, and 140d while each of the syringe support members 140a, 140b, 140c, and 140d is coupled to the second frame 120, thereby improving the ease of use of the liquid injection device 1.

The rotation shaft 200 is rotatably supported by the frame 100.

In the present embodiment, one end of the rotation shaft 200 may be rotatably supported by the first frame 110, and the other end of the rotation shaft 200 may be rotatably supported by the bracket 130 coupled to the second frame 120.

The rotation shaft 200 may extend in one direction (e.g., a Y-axis direction when viewed in FIGS. 1 to 6).

Referring to FIGS. 5 and 6, one end and the other end in the longitudinal direction of the rotation shaft 200 have a circular transverse section. In this case, one end of the rotation shaft 200 may be rotatably supported by the first frame 110, and the other end of the rotation shaft 200 may be rotatably supported by the bracket 130 vertically coupled to the second frame 120.

The rest of the rotation shaft 200 except for the one end and the other end have a polygonal transverse section or a deformed circular transverse section in which an uneven portion is formed in the circumferential direction on the outer circumferential surface. In this case, the plurality of pinions 401, 402, 403, and 404 coupled to the rotation shaft 200 while the rotation shaft 200 passes through may rotate integrally with the rotation shaft 200 without slipping in the rotation direction of the rotation shaft 200 with respect to the rotation shaft 200 when the rotation shaft 200 rotates.

Referring to FIG. 2, the rotation driving unit 300 rotates the rotation shaft 200.

The rotation driving unit 300 according to the present embodiment operates without external power, for example, external electric power.

For example, the rotation driving unit 300 may include a spiral spring 310, a driving gear 320, and a driven gear 330.

The spiral spring 310 provides rotational driving force by rolling and unwinding a thin and long steel band. The spiral spring 310 may be seated in the seating groove 111 of the first frame 110.

The driving gear 320 is coupled to the rotation shaft 200 of the spiral spring 310.

On one surface of the driving gear 320, a handle portion 324 gripped by an operator may be formed to rotate the rotation shaft 200 of the spiral spring 310.

The driven gear 330 is fixedly coupled to the rotation shaft 200 and rotates in engagement with the driving gear 320.

The rotation driving unit 300 configured as described above rotates the rotation shaft 200 in such a way that after an operator rotates the handle portion 324 to accumulate the rotational driving force on the spiral spring 310, the rotational driving force accumulated in the spiral spring 310 is transmitted to the rotation shaft 200 through the driving gear 320 and the driven gear 330.

The driving device 10 according to the present embodiment may operate without external power by using the rotation driving unit 300 including the spiral spring 310, thereby having good portability, convenience, and being eco-friendly.

Referring to FIGS. 1 to 6, a plurality of pinions 401, 402, 403, and 404 may be fixedly coupled to the rotation shaft 200. In the present embodiment, four pinions 401, 402, 403, and 404 may be applied. Hereinafter, for convenience of description, the four pinions 401, 402, 403, and 404 are referred to as a first pinion 401, a second pinion 402, a third pinion 403, and a fourth pinion 404 in order close to the first frame 110.

The plurality of pinions 401, 402, 403, and 404 are engaged with a plurality of corresponding racks 501, 502, 503, and 504. The plurality of racks 501, 502, 503, and 504 are engaged with the plurality of corresponding pinions 401, 402, 403, and 404 to move forward in a direction perpendicular to the longitudinal direction of the rotation shaft 200. For reference, in FIGS. 1 to 6, the longitudinal direction of the rotation shaft 200 is the Y-axis direction, and the forward direction of the racks 501, 502, 503, and 504 is the +X direction.

In the present embodiment, four racks 501, 502, 503, and 504 may be applied corresponding to the four pinions 401, 402, 403, and 404. Hereinafter, racks 501, 502, 503, and 504 corresponding to the first pinion 401, the second pinion 402, the third pinion 403, and the fourth pinion 404 will be referred to as a first rack 501, a second rack 502, a third rack 503, and a fourth rack 504, respectively.

In the present embodiment, the four pinions 401, 402, 403, and 404 and the four racks 501, 502, 503, and 504 that respectively correspond to each other are sequentially engaged. In the present embodiment, it is assumed that as for the engagement order of the pinions 401, 402, 403, and 404 and the racks 501, 502, 503, and 504 that respectively correspond to each other, the first is the engagement of the first pinion 401 and the first rack 501, the second is the engagement of the second pinion 402 and the second rack 502, the third is the engagement of the third pinion 403 and the third rack 503, and the fourth is the engagement of the fourth pinion 404 and the fourth rack 504. However, the order of engagement of the corresponding four pinions and the four racks may be variously modified.

A through hole having a shape corresponding to a transverse section of the rotation shaft 200 may be formed in the central portion of each of the pinions 401, 402, 403, and 404. Each of the pinions 401, 402, 403, and 404 may be coupled to the rotation shaft 200 in a form in which the rotation shaft 200 passes through the through hole.

Each of the pinions 401, 402, 403, and 404 is disposed to be spaced apart from each other in the longitudinal direction of the rotation shaft 200.

Gear teeth 401a, 402a, 403a, and 404a that engage with the gear teeth 501a, 502a, 503a, and 504a of each of the corresponding racks 501, 502, 503, and 504 are formed on each of the pinions 401, 402, 403, and 404. The gear teeth 401a 402a, 403a, and 404a of each of the pinions 401, 402, 403, and 404 are formed in a partial region in the circumferential direction of each of the pinions 401, 402, 403, and 404.

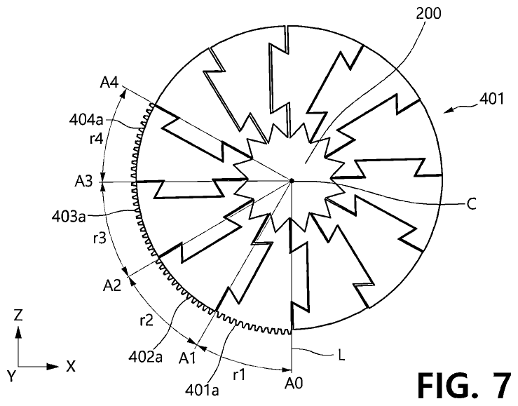

FIG. 7 is a view for explaining a gear teeth formation range of a plurality of pinions according to an exemplary embodiment of the present invention. For reference, in FIG. 7, the second pinion (402 in FIG. 2), the third pinion (403 in FIG. 2), and the fourth pinion (404 in FIG. 2) are barely visible as they are covered by the first pinion 401.

Referring to FIGS. 3 and 7, the formation range of the gear teeth 401a 402a, 403a, and 404a of each of the pinions 401, 402, 403, and 404 has different angular ranges in the circumferential direction of the rotation shaft 200.

For example, the formation range of the gear teeth 401a 402a, 403a, and 404a of each of the pinions 401, 402, 403, and 404 may be defined as a lower limit angle and an upper limit angle with respect to a reference line L passing through the center C of the rotation shaft 200 on a plane perpendicular to the rotation shaft 20.

Here, the reference line L may be defined as a straight line (e.g., a straight line extending in the direction of 6 o'clock in FIG. 7) that passes a start point in the circumferential direction of the rotation shaft 200 of the first gear tooth 401a of the first pinion 401. The circumferential direction of the rotation shaft 200 used when defining the reference line L in the present embodiment may be a direction opposite to the rotation direction of the rotation shaft 200.

For reference, in FIG. 7, the rotation direction of the rotation shaft 200 may be a counterclockwise direction, and the circumferential direction of the rotation shaft 200 used to define the reference line L may be a clockwise direction opposite to the rotation direction of the rotation shaft 200.

The lower limit angle of the formation range of each of the gear teeth 401a, 402a, 403a, and 404a is defined as a contained angle between the reference line L and a straight line connecting a starting point in the circumferential direction of each of the gear teeth 401a, 402a, 403a, and 404a of the rotation shaft 200 and the center C of the rotation shaft.

The upper limit angle of the formation range of each of the gear teeth 401a, 402a, 403a, and 404a is defined as a contained angle between the reference line L and a straight line connecting an end point in the circumferential direction of each of the gear teeth 401a, 402a, 403a, and 404a and the center C of the rotation shaft 200.

For example, the formation range r1 of a gear tooth (hereinafter, referred to as a “first gear tooth 401a”) formed in a partial region of the circumferential direction of the first pinion 401 may be A0 or more and A1 or less.

The formation range r2 of a gear tooth (hereinafter, referred to as a “second gear tooth 402a”) formed in a partial region of the circumferential direction of the second pinion 402 may be A1 or more and A2 or less.

The formation range r3 of a gear tooth (hereinafter, referred to as a “third gear tooth 403a”) formed in a partial region of the circumferential direction of the third pinion 403 may be A2 or more and A3 or less.

The formation range r4 of a gear tooth (hereinafter, referred to as a “fourth gear tooth 404a”) formed in a partial region of the circumferential direction of the fourth pinion 404 may be A3 or more and A4 or less.

Here, the lower limit angle A0 of the first gear tooth 401a may be defined as 0 degrees.

As such, if the formation ranges r1, r2, r3, and r4 of the first gear tooth 401a, the second gear tooth 402a, the third gear tooth 403a, and the fourth gear tooth 404a are different from each other, the engagement of the pinions 401, 402, 403, and 404 and the racks 501, 502, 503, and 504 that respectively correspond to each other may be sequentially performed when the rotation shaft 200 rotates.

According to the present embodiment, in the order of sequential engagement of the pinions 401, 402, 403, and 404 and the racks 501, 502, 503, and 504 that respectively correspond to each other, the formation range of the gear teeth of the prior order pinion and the formation range of the gear teeth of the subordinate order pinion may partially overlap.

For example, referring to FIG. 7, the second pinion 402 among the pinions 401, 402, 403, and 404 is the second pinion in the order of pinion-rack engagement. The formation range r2 of the second gear tooth 402a of the second pinion 402 is A1 or more and A2 or less, the formation range r1 of the first gear tooth 401a of the first pinion 401, which is the prior order than the second pinion 402 in the order of pinion-rack engagement, is A0 or more and A1 or less, and the formation range r3 of the third gear tooth 403a of the third pinion 403, which is the subordinate order than the second pinion 402 in the order of pinion-rack engagement, is A2 or more and A3 or less.

In this case, the formation ranges r1 and r2 of the first gear tooth 401a and the second gear tooth 402a partially overlap at a specific angle A1, and the formation ranges r2 and r3 of the second gear tooth 402a and the third gear tooth 403a partially overlap at a specific angle A2.

In this case, the second pinion 402 and the second rack 502 are engaged immediately at the end of the engagement between the first pinion 401 and the first rack 501 while the rotation shaft 200 is rotating, and the third pinion 403 and the third rack 503 are engaged immediately at the end of the engagement between the second pinion 402 and the second rack 502.

In other words, while the rotation shaft 200 rotates, the timing of the end of the engagement between the first pinion 401 and the first rack 501 and the timing of the start of the engagement between the second pinion 402 and the second rack 502 are the same, and the timing of the end of the engagement between the second pinion 402 and the second rack 502 is the same as the timing of the start of the engagement between the third pinion 403 and the third rack 503.

Meanwhile, as shown in FIG. 7 in the present embodiment, the gear teeth 401a, 402a, 403a, and 404a of the pinions 401, 402, 403, and 404 are formed so that the formation ranges of the gear teeth of the prior order pinion and the subordinate order pinion overlap at a specific angle in the pinion-rack engagement order.

In another embodiment not shown, the gear teeth of the pinions may be formed such that the formation ranges of the gear teeth of the prior order pinion and the immediately next subordinate order pinion in the order of the pinion-rack engagement partially overlap in a specific angular range.

In this case, in the order of the pinion-rack engagement, the engagement of the immediately next subordinate order pinion and the corresponding subordinate order rack may begin immediately before the engagement of the prior order pinion and the corresponding prior order rack ends.

According to another embodiment not shown, the formation range of the gear teeth of the prior order pinion and the formation range of the gear teeth of the subordinate order pinion may not overlap in the order of sequential engagement of mutually corresponding pinions and racks.

In this case, in the order of the pinion-rack engagement, the engagement of the immediately next subordinate order pinion and the corresponding subordinate order rack may begin after a predetermined period of time is lapsed after the end of the engagement of the prior order pinion and the corresponding prior order rack.

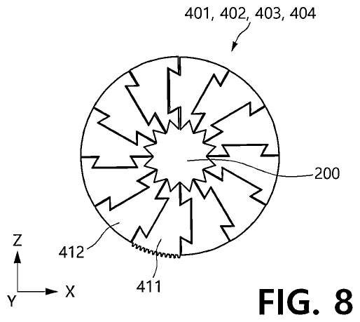

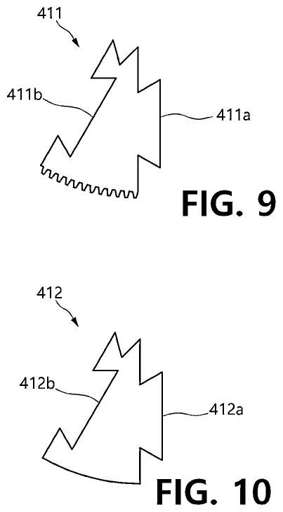

FIG. 8 is a view showing a pinion according to an exemplary embodiment of the present invention, FIG. 9 is a view showing a first pinion unit shown in FIG. 8, and FIG. 10 is a view showing a second pinion unit constituting the pinion shown in FIG. 8.

Referring to FIGS. 8 to 10, each of the pinions 401, 402, 403, and 404 may include a plurality of pinion units 411 and 412.

Each of the pinions 401, 402, 403, and 404 may include a plurality of pinion units 411 and 412 coupled to each other in the circumferential direction of the rotation shaft 200.

At least one of the plurality of pinion units 411 and 412 may be a first pinion unit 411 having gear teeth formed on an outer circumferential surface thereof, and the rest may be a second pinion unit 412 having no gear teeth formed on an outer circumferential surface thereof.

In FIG. 8, the number of first pinion units 411 included in each of the pinions 401, 402, 403, and 404 is shown as one, but this is only an example, and each of the pinions 401, 402, 403, and 404 may include two or more first pinion units 411.

However, the number and coupling position of the first pinion units 411 constituting each of the pinions 401, 402, 403, and 404 may be determined so that the plurality of pinions 401, 402, 403, and 404 and the plurality of racks 501, 502, 503, and 504 that respectively correspond to each other are sequentially engaged.

The plurality of pinion units 411 and 412 constituting each of the pinions 401, 402, 403, and 404 may be coupled to each other in the circumferential direction of the rotation shaft 200.

To this end, each of the plurality of pinion units 411 and 412 constituting each of the pinions 401, 402, 403, and 404 may include a protruding coupling portion 411a, 412a and a concave coupling portion 411b, 412b for coupling with adjacent other pinion units at one side and the other side in the circumferential direction of the rotation shaft 200.

In more detail, the plurality of pinion units 411 and 412 constituting each of the pinions 401, 402, 403, and 404 may include a protruding coupling portion 411a, 412a and a concave coupling portion 411b, 412b formed on one side and the other side in the circumferential direction of the rotation shaft 200, respectively.

In this case, the protruding coupling portion 411a, 412a of each of the pinion units 411 and 412 may be coupled to the concave coupling portion of an adjacent other pinion unit at one side of the corresponding pinion unit, and the concave coupling portion 411b, 412b of each of the pinion units 411 and 412 may be coupled to the protruding coupling portion of an adjacent other pinion unit at the other side of the corresponding pinion unit.

The plurality of pinion units 411 and 412 constituting each of the pinions 401, 402, 403, and 404 may be standardized and fabricated.

In this case, an operator may easily fabricate the pinions 401, 402, 403, and 404 by combining the standardized pinion units 411 and 412, and thus the ease of manufacture of the pinions 401, 402, 403, and 404, and the driving device 10 including the same may be improved.

Furthermore, if the pinions 401, 402, 403, and 404 are partially damaged, only the pinion unit 411, 412 corresponding to the damaged areas can be repaired and replaced, making it easy and economical to maintain and repair the pinions 401, 402, 403, 404.

Referring to FIGS. 1 to 3, a plurality of racks 501, 502, 503, and 504 are engaged with a plurality of pinions 401, 402, 403, and 404.

For example, the first rack 501 is engaged with the first pinion 401, the second rack 502 is engaged with the second pinion 402, the third rack 503 is engaged with the third pinion 403, and the fourth rack 504 is engaged with the fourth pinion 404.

Each of the racks 501, 502, 503, and 504 extends in a direction perpendicular to the longitudinal direction of the rotation shaft 200 (e.g., the X-axis direction in FIGS. 1 to 3).

Gear teeth 501a, 502a, 503a, and 504a that engage with the gear teeth 401a, 402a, 403a, and 404a of each of the corresponding pinions 401, 402, 403, and 404 are formed in the longitudinal direction on one surface of each of the racks 501, 502, 503, and 504.

The plurality of racks 501, 502, 503, and 504 are disposed to be spaced apart from each other in the longitudinal direction of the rotation shaft 200.

In the present embodiment, each of the racks 501, 502, 503, and 504 sequentially engaged with each of the pinions 401, 402, 403, and 404 while the rotation shaft 200 rotates sequentially advances in a direction (e.g., the +X-axis direction in FIGS. 1 to 3) perpendicular to the longitudinal direction of the rotation shaft 200.

To this end, guides 123a, 123b, 123c, and 123d to which the respective racks 501, 502, 503, and 504 are coupled may be formed in the frame 100 as shown in FIG. 4. In this case, the guides 123a, 123b, 123c, and 123d guide the forward movement of each of the racks 501, 502, 503, and 504.

Each of the guides 123a, 123b, 123c, and 123d is formed to extend in the forward direction (e.g., the +X-axis direction in FIGS. 1 to 3) of each of the racks 501, 502, 503, and 504.

A plurality of guides 123a, 123b, 123c, and 123d may be spaced apart from each other in the longitudinal direction of the rotation shaft 200 to be formed in the frame 100.

In the present embodiment, each of the guides 123a, 123b, 123c and 123d may have a protrusion shape protruding from one surface of the frame 100 as shown in FIGS. 3 and 4. In this case, a guide groove 510a, 510b, 510c, 510d coupled to each of the guides 123a, 123b, 123c, and 123d may be formed in each of the racks 501, 502, 503, and 504 slidably coupled to each of the guides 123a, 123b, 123c, and 123d.

Alternatively, although not shown, each guide may have a groove shape concavely formed on one surface of the frame. In this case, a guide protrusion coupled to each guide may be formed in each rack slidably coupled to each guide.

The driving device 10 according to the present embodiment discussed above is configured such that a plurality of racks 501, 502, 503, and 504 that engage corresponding to a plurality of pinions 401, 402, 403, and 404 that rotate together when the rotation shaft 200 rotates move forward sequentially, thereby providing a sequential driving force to a plurality of syringes 31, 32, 33, and 34 so that the plurality of syringes 31, 32, 33, and 34 in which different liquids are stored sequentially inject.

Furthermore, the driving device 10 according to the present embodiment may operate without external power by using the rotation driving unit 300 including the spiral spring 310, thereby improving portability and convenience, and being eco-friendly.

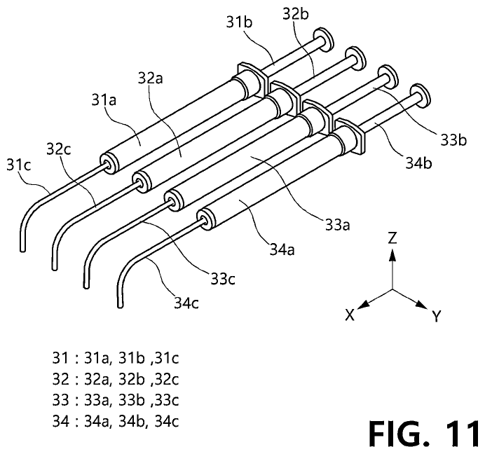

FIG. 11 is a view showing a plurality of syringes included in a liquid injection device according to an exemplary embodiment of the present invention.

Referring to FIGS. 1, 2 and 11, a plurality of syringes 31, 32, 33, and 34 correspond to a plurality of racks 501, 502, 503, and 504, respectively. In the present embodiment, four syringes 31, 32, 33, and 34 may be applied as shown in FIGS. 1 and 11.

Hereinafter, for convenience of explanation, among the four pinions 401, 402, 403, and 404, the one corresponding to the first rack 501 is referred to as a first syringe 31, the one corresponding to the second rack 502 is referred to as a second syringe 32, the one corresponding to the third rack 503 is referred to as a third syringe 33, and the one corresponding to the fourth rack 504 is referred to as a fourth syringe 34.

Each syringe 31, 32, 33, 34 may include a cylinder 31a, 32a, 33a, 34a, a piston 31b, 32b, 33b, 34b, and a needle 31c, 32c, 33c, 34c.

The cylinder 31a, 32a, 33a, 34a stores a liquid, the piston 31b, 32b, 33b, 34b provides pressure to push the liquid in the cylinder 31a, 32a, 33a, 34a, and the needle 31c, 32c, 33c, 34c discharges the liquid in the cylinder 31a, 32a, 33a, 34a compressed by the piston 31b, 32b, 33b, 34b to the outside.

A piston locking portion 520a, 520b, 520c, 520d may be formed at a front end in the forward direction (e.g., in the +X direction in FIG. 2) of each of the racks 501, 502, 503, and 504. A piston flange formed at the end of the piston 31b, 32b, 33b, 34b of each syringe 31, 32, 33, 34 may be caught and supported by each piston locking portion 520a, 520b, 520c, 520d corresponding thereto.

The cylinder 31a, 32a, 33a, 34a of each syringe 31, 32, 33, 34 may be supported by the frame 100 in a state of being supported by each syringe support member 140a, 140b, 140c, 140d. In this case, the cylinder flange formed at the end of the cylinder 31a, 32a, 33a, 34a of each syringe 31, 32, 33, 34 may be caught and supported on one side of each syringe support member 140a, 140b, 140c, 140d.

The needle 31c, 32c, 33c, 34c of each syringe 31, 32, 33, 34 may extend to an injection target member P. The needle 31c, 32c, 33c, 34c of each syringe 31, 32, 33, 34 may be coupled to the injection target member P.

A plurality of sub flow paths P11, P12, P13, and P14, and a main flow path P20 in which and a plurality of sub flow paths P11, P12, P13, and P14 are combined may be formed in the injection target member P. The plurality of sub flow paths P11, P12, P13, and P14 are connected to the plurality of syringes 31, 32, 33, and 34, correspondingly. That is, the needles 31c, 32c, 33c, and 34c of the plurality of syringes 31, 32, 33, and 34 are connected to the corresponding plurality of sub flow paths P11, P12, P13, and P14, and the liquid stored in the plurality of syringes 31, 32, 33, and 34 may be injected into the corresponding plurality of sub flow paths P11, P12, P13, and P14.

A fixing portion P30 to which a specific object is fixed may be formed on the main flow path P20.

The liquid injected from each of the syringes 31, 32, 33, and 34 may move to the main flow path P20 through the corresponding sub flow paths P11, P12, P13, and P14. In this process, the liquid injected from each of the syringes 31, 32, 33, and 34 may sequentially pass through the fixing portion P30 and sequentially react with a specific object or the like placed on the fixing portion P30.

In the liquid injection device 1 according to the present embodiment discussed above, the driving device 10 that sequentially provides a driving force to the plurality of syringes 31, 32, 33, and 34 may operate to sequentially inject different liquids stored in each of the plurality of syringes 31, 32, 33, and 34 in an accurate amount into an injection target member P.

Accordingly, the liquid injection device 1 may inject different liquids sequentially and in an accurate amount without operator intervention, reducing cross-contamination and enabling more accurate analysis and diagnosis compared to when operators manually inject different liquids.

In addition, the liquid injection device can be recognized as an eco-friendly device with improved portability and convenience by including a driving device that provides driving force without external power.

Such a liquid injection device 1 may be used in a technical field involving the process of sequentially injecting several liquids, such as an immunoassay field or an immunodiagnosis field.

Hereinafter, a use case of the liquid injection device 1 according to an exemplary embodiment of the present invention will be described with reference to FIG. 1.

The liquid injection device 1 according to the present embodiment may be used for gold nanoparticle-based immunoassay.

In more detail, a capture antibody of a target to be detected may be fixed to the fixing portion P30 of the injection target member P.

A first liquid, a second liquid, a third liquid, and a fourth liquid are stored in the first syringe 31, the second syringe 32, the third syringe 33, and the fourth syringe 34 of the liquid injection device 1, respectively. The first liquid includes an antigen, which is a target to be detected, the second liquid includes a labeled antibody to which gold nanoparticles are bound, the third liquid includes a gold nanoparticle reinforcing agent for amplifying the signal of the gold nanoparticles, and the fourth liquid includes a cleaning agent for removing the gold nanoparticle reinforcing agent.

The liquid injection device 1 operates to inject the first liquid, the second liquid, the third liquid, and the fourth liquid into the injection target member P in the first, second, third, and fourth order, respectively.

To this end, the driving device 10 of the liquid injection device 1 operates so that the first rack 501, the second rack 502, the third rack 503 and the fourth rack 504 corresponding to the first syringe 31, the second syringe 32, the third syringe 33, and the fourth syringe 34 move forward sequentially.

When the liquid injection device 1 operates, immunoassay may be performed in the following process.

First, the first liquid is injected into the injection target member P. In this case, the first liquid moves to the fixing portion P30 through the corresponding sub flow path P11 and the main flow path P20, and the antigen contained in the first liquid is bound to the capture antibody fixed to the fixing portion P30. In this case, an object obtained by binding the antigen and the capture antibody is referred to as a first object.

Second, the second liquid is injected into the injection target member P. In this case, the second liquid moves to the fixing portion P30 through the corresponding sub flow path P12 and the main flow path P20, and the labeled antibody to which the gold nanoparticles contained in the second liquid are bound is bound to the first object previously generated in the fixing portion P30. In this case, a generated object obtained by binding the labeled antibody to which the gold nanoparticles are bound and the first object is referred to as a second object.

Third, the third liquid is injected into the injection target member P. In this case, the third liquid moves to the fixing portion P30 through the corresponding sub flow path P13 and the main flow path P20, and the cleaning agent contained in the third liquid removes the gold nanoparticles non-specifically distributed in the main flow path P20 and the fixing portion P30.

Fourth, the fourth liquid is injected into the injection target member P. In this case, the fourth liquid moves to the fixing portion P30 through the corresponding sub flow path P14 and the main flow path P20, and the gold nanoparticle reinforcing agent contained in the fourth liquid is bound to the second object previously generated in the fixing portion P30. In this case, an object obtained by binding the gold nanoparticle reinforcing agent and the second object is referred to as a third object. The color development signal of the third object is stronger than the color development signal of the second object.

Through the above process, the third object fixed to the fixing portion P30 may be analyzed to detect an antigen, which is a target to be detected.

However, of course, the liquid injection device 1 according to an exemplary embodiment of the present invention may be not only used for gold nanoparticle-based immunoassay as described above, but also be used in a technical field involving the process of sequentially injecting several liquids, such as an immunoassay field or an immunodiagnosis field.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the idea scope of the present invention.

<Description of Symbols>

```
  1: liquid injection device
  10: driving device
  31: first syringe
  32: second syringe
  33: third syringe
  34: fourth syringe
  31a, 32a, 33a, 34a: cylinder
  31b, 32b, 33b, 34b: piston
  31c, 32c, 33c, 34c: needle
100: frame
110: first frame
111: seating groove
113: support groove
120: second frame
121a, 121b, 121c, 121d:
coupling groove portion
123a, 123b, 123c, 123d: guide
130: bracket
140a, 140b, 140c, 140d:
syringe support member
200: rotation shaft
300: rotation driving unit
310: spiral spring
320: driving gear
324: handle portion
330: driven gear
401: first pinion
401a: first gear tooth
402: second pinion
402a: second gear tooth
403: third pinion
403a: third gear tooth
404: fourth pinion
404a: fourth gear tooth
411: first pinion unit
412: second pinion unit
411a, 412a: protruding coupling portion
411a, 412b: concave coupling portion
501: first rack
502: second rack
503: third rack
504: fourth rack
510a, 510b, 510c, 510d: guide groove
520a, 520b, 520c, 520d:
piston locking portion
P: injection target member
P11, P12, P13, P14: sub flow path
P20: main flow path
P30: fixing portion
```

What is claimed is:

1. A driving device, comprising:
a frame;
a rotation shaft rotatably supported by the frame;
a rotation driving unit configured to rotate the rotation shaft;
a plurality of pinions configured to be spaced apart in the longitudinal direction of the rotation shaft and respectively coupled to the rotation shaft; and
a plurality of racks configured to be engaged with the plurality of pinions, respectively and configured to move forward in a direction perpendicular to the longitudinal direction of the rotation shaft,
wherein when the rotation shaft rotates, the engagement of the plurality of pinions and the plurality of racks that respectively correspond to each other is sequentially performed.

2. The driving device of claim 1, wherein the rotation driving unit is configured to operate without external power.

3. The driving device of claim 2,
wherein the rotation driving unit comprises:
a spiral spring;
a driving gear coupled to a rotation shaft of the spiral spring; and
a driven gear fixedly coupled to the rotation shaft and configured to rotate in engagement with the driving gear.

4. The driving device of claim 1, wherein a seating groove is formed in the frame, the spiral spring being coupled to and seated in the seating groove.

5. The driving device of claim 1, wherein the formation range of gear teeth of each of the plurality of pinions has a different angular range in the circumferential direction of the rotation shaft.

6. The driving device of claim 5, wherein in the order of sequential engagement of the plurality of pinions and the plurality of racks that respectively correspond to each other, the formation range of the gear teeth of a prior order pinion and the formation range of the gear teeth of a subordinate order pinion partially overlap.

7. The driving device of claim 5, wherein in the order of sequential engagement of the plurality of pinions and the plurality of racks that respectively correspond to each other, the formation range of the gear teeth of a prior order pinion and the formation range of the gear teeth of a subordinate order pinion do not overlap.

8. The driving device of claim 1,
wherein each of the plurality of pinions comprises a plurality of pinion units coupled to each other in the circumferential direction of the rotation shaft,
wherein at least one of the plurality of pinion units is a first pinion unit having gear teeth formed on an outer circumferential surface thereof, and the rest is a second pinion unit having no gear teeth formed on an outer circumferential surface thereof.

9. The driving device of claim 8, wherein each of the plurality of pinion units includes a protruding coupling portion and a concave coupling portion for coupling with adjacent other pinion units at one side and the other side in the circumferential direction of the rotation shaft.

10. The driving device of claim 1, wherein a plurality of guides coupled to the plurality of racks, respectively, and configured to guide the forward movement of the plurality of racks, respectively, are formed in the frame.

11. A liquid injection device, comprising:
the driving device according to claim 1; and
a plurality of syringes supported by the frame, the plurality of syringes corresponding to the plurality of racks, respectively,
wherein the plurality of syringes are compressed by being pushed by corresponding ends of the plurality of racks, respectively, and
different liquids are stored in the plurality of syringes, respectively.

12. The liquid injection device of claim 11, wherein the plurality of syringes are supported by the frame through a plurality of syringe coupling members detachably coupled to the frame, respectively.

13. The liquid injection device of claim 11,
wherein the liquids stored in the plurality of syringes, respectively, are sequentially injected to an injection target member,
wherein a plurality of sub flow paths through which the liquids stored in the plurality of syringes, respectively, are sequentially injected, and a main flow path in which the plurality of sub flow paths are combined are formed in the injection target member,
wherein a fixing portion to which a specific object is formed on the main flow path.
